(19) United States
(12) Patent Application Publication
(10) Pub. No.: US 2008/0183547 A1
(43) Pub. Date: Jul. 31, 2008

(54) Clinical Rotation Scheduling System

(75) Inventor: Dominique Halaby, Rancho Viejo, TX (US)

Correspondence Address: FISH & RICHARDSON P.C., P.O BOX 1022, Minneapolis, MN, 55440-1022, US

(73) Assignee: VALLEY INITIATIVE FOR DEVELOPMENT AND ADVANCEMENT, Weslaco, TX (US)

(21) Appl. No.: 11/669,698

(22) Filed: Jan. 31, 2007

(51) Int. Cl. G06F 9/46; G06F 15/02

(52) U.S. Cl. 705/9

(57) ABSTRACT

There is provided a clinical rotation scheduling system. More specifically, in one embodiment, there is provided a computerized method comprising accessing first clinical rotation related information associated with a school, accessing second clinical rotation related information associated with a medical facility, and creating a clinical rotation schedule based on the first information and the second information.

### BACKGROUND

Doctors, physician assistants, nurses, and other medical caregivers generally spend many years in school learning their craft. As part of their medical training, many of these caregivers also spend at least some portion of their time in hospitals or other medical institutions. These stints in hospitals or other medical institutions are known as clinical rotations or simply as “clinicals”. Clinical rotations are an important part of the learning process for most caregivers. In fact, clinical rotations are often required by state law for licensure and/or required by medical and nursing schools to graduate.

### DESCRIPTION OF DRAWINGS

FIG. 1 illustrates a view of an exemplary clinical infrastructure in accordance with one embodiment;

FIG. 2 illustrates one example of a clinical infrastructure configured in accordance with one embodiment of the infrastructure of FIG. 1;

FIG. 3 is a flow chart illustrating an exemplary technique for managing clinical rotations in accordance with one embodiment;

FIG. 4 is a flow chart illustrating an exemplary technique for requesting the creating of a new clinical rotation in accordance with one embodiment;

FIG. 5 illustrates an exemplary clinical rotation selection screen in accordance with one embodiment;

FIG. 6 is a flow chart illustrating an exemplary technique for creating a clinical rotation schedule in accordance with one embodiment; and

FIG. 7 is a flow chart illustrating an exemplary technique for assigning students to a clinical rotation in accordance with one embodiment.

### DETAILED DESCRIPTION

One or more of the embodiments set forth below are directed towards a clinical rotation management system and related systems and methods. For example, in one configuration, there is provided a clinical rotation management system that may be configured to receive school information and medical facility information and to create and/or manage one or more clinical rotation schedules for the medical facility based on this information as well as any one of a number of other suitable parameters. The system may also be also configured enable the schools or medical facilities to edit or adjust clinical rotation schedules, to request new clinical rotations, and/or to notify the schools, students, faculty, or medical facility of the clinical rotation schedules.

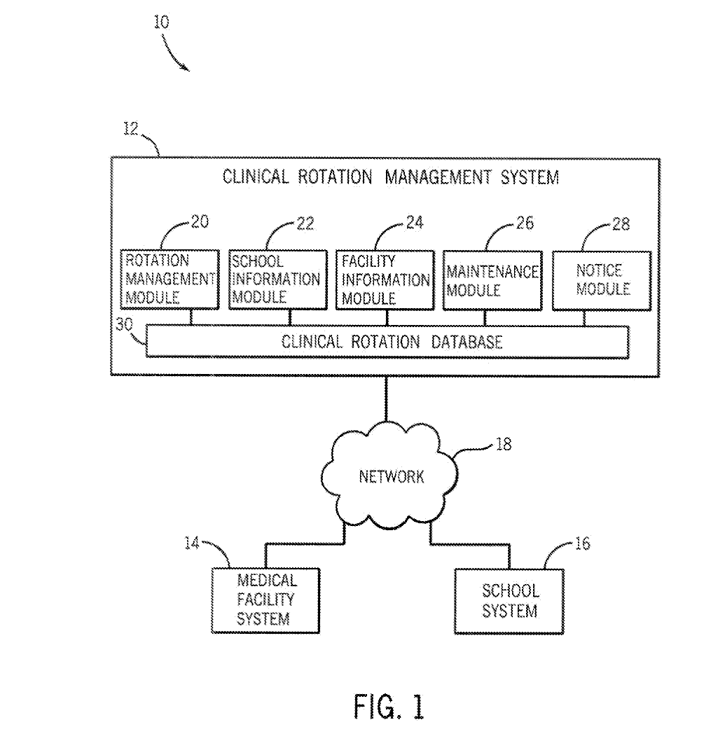

FIG. 1 illustrates a view of an exemplary clinical infrastructure 10 in accordance with one embodiment. The clinical infrastructure 10 illustrated in FIG. 1 may include a clinical rotation management system 12, a medical facility system 14, and a school system 16, which are interconnected by a network 18. Although the infrastructure 10 is illustrated as including a single instance of each of the systems 12, 14, and 16, it will be appreciated that this singularity is for illustrative purposes only. As such, in alternate embodiments, the infrastructure 10 may include any one of a suitable number of these systems. For example, the infrastructure 10 may include several medical facility systems 14 and several school systems 16.

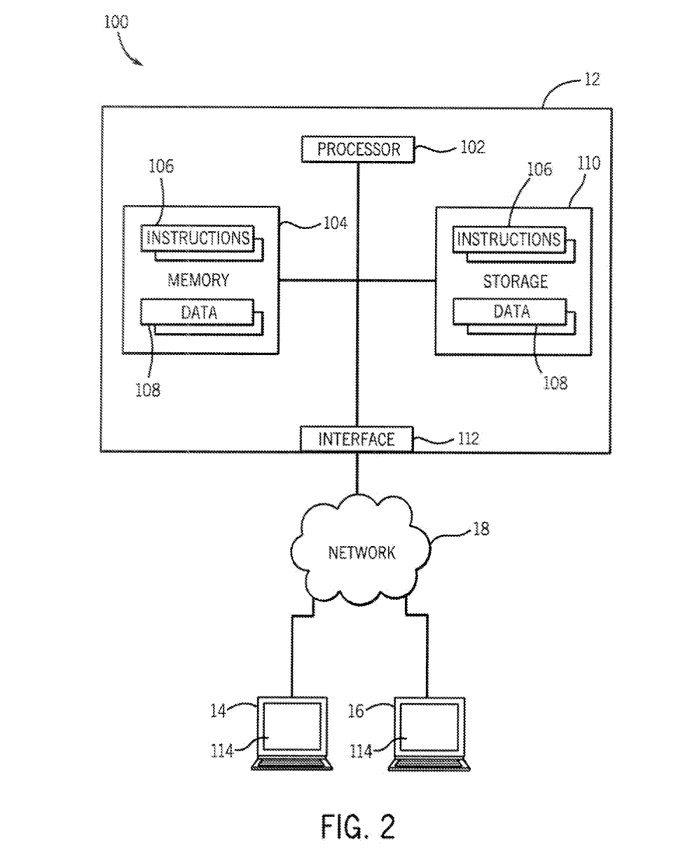

Looking closer at the clinical rotation management system 12, the system 12 may include a rotation management module 20, a school information module 22, a faculty information module 24, a maintenance module 26, and a notice module 28. In various embodiments, one of which is described in more detail below with regard to FIG. 2, the modules 20-28 may include any suitable form of hardware, software, firmware, and/or combination of hardware, software, and firmware. For example, in one embodiment, the modules 20-28 may be created by a computer executing code stored on a computer readable medium, such as a computer memory or storage disk.

As illustrated, the clinical rotation management system 12 may also include a clinical rotation database 30. The database 30 may serve as a central repository for clinical rotation related information within the system 12. The modules 20-28 may store newly received information (e.g., a newly created clinical rotation schedule, information on a new student, etc.) in the database 30 such that other modules may access that information at a later time. For example, the rotation management module 20 may access the stored student information or facility information when creating a new clinical rotation schedule or updating an existing clinical rotation schedule. In various embodiments, any suitable database may be employed as the clinical rotation database 30. For example, the database 30 may be an ACCESS database, a SQL database, an ORACLE database, and so forth. Moreover, in some configurations, the database 30 may be external to the system 12 and coupled to the system 12 by a cable, by the network 18, or by another suitable link.

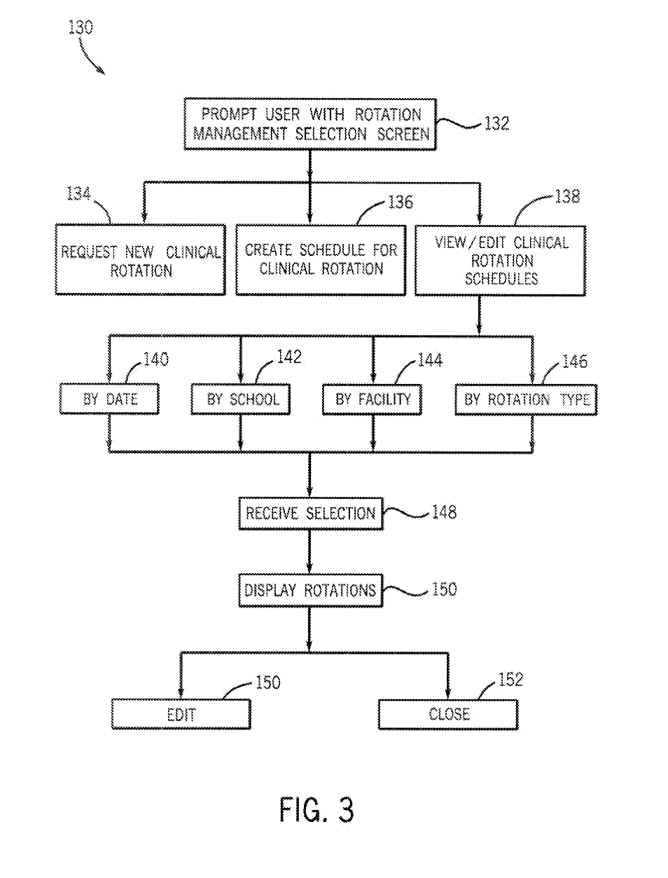

As will be described further below with regard to FIG. 3, the rotation management module 20 may be configured to enable users to request the creation of new clinical rotations. For example, in one embodiment, the rotation management module 20 may be configured to generate a data input screen that enables a school administrator to request approval for a new clinical rotation from a medical facility, such as a hospital, clinic, or doctor's office. The rotation management module 20 may also be configured to create clinical rotation schedules and to enable users to view/edit the created clinical rotation schedules.

The school information module 22 may be configured to receive and manage information related to clinical rotations from one or more schools, such as a medical school, a physician's assistant (“PA”) school, a nursing school, or other caregiver educational school or institution. For example, the school information module may be configured to store the school information in the clinical rotation database 30. The stored information may then be employed by the rotation management module 20 to create and manage clinical rotation schedules. Accordingly, the school information module 22 may receive and manage any one of a number of suitable types of clinical rotation related data. For example, the module 22 may receive student information, faculty information, course information, affiliation information, and/or preference information.

The student information may include, but is not limited to a student's name, ID number, gender, contact information (e.g., address, telephone numbers, email addresses), semester/year in school, background check status, qualifications (e.g., CPR certification, drug screening, immunizations, security clearance, and so forth), class schedules, addresses, grades, course numbers and schedules, health records, currently scheduled clinical rotations, desired clinical rotations, emergency contact information, special accommodations, travel restrictions (e.g., maximum travel time), workday preferences, and the like.

Faculty information may include, but is not limited to, faculty names, titles, offices, addresses, contact information (e.g., phone numbers, email addresses), degrees, medical certifications, courses taught, course schedules, photographs, qualifications (e.g., background checks, CPR certification, drug screening, immunization records, security clearance, and the like), schedules, assigned rotations, faculty status, and so forth. Course information may include course names, course type (e.g., clinical rotation or lecture) semester/year taught, course number, course description, usual faculty, assigned faculty, course duration, course size, rotation group information, course site, start times, end times, pre-rotation and post-rotation times for students and faculty, and so forth.

Affiliation information may include details, such as starting and ending dates, of affiliation agreements between the school and any medical facilities that are affiliated with it. It will be appreciated that the clinical rotation management system 12 may be configured to only schedule clinical rotations for students of a particular school with medical facilities that have an affiliation agreement in effect with the school.

Preference information may include information regarding any medical facility preferences that the school has for its clinical rotations. For example, when it comes to catheter lab facilities, the preference information may indicate that medical center A is the preferred site, medical center B is the second most preferred, and so forth. The school information module 22 may also be configured to store school specific identification information such as the school's name, abbreviation, address, administrator or contact's name, other contact information (e.g., phone numbers and email addresses), description, course schedules, rotation history, and so forth.

In addition to receiving and storing the school information, the school information module 22 may also be configured to enable a user, such as a school administrator, a student, or a faculty member to view and/or edit some or all of the stored school information. For example, the school information module 22 may enable a user to view the student information for a particular student, to edit that information (e.g., add a new qualification or preference), and then to resave that information. Similarly, the user could view or edit faculty information or course information, add/edit/delete affiliation agreements, or change the school's faculty preferences. It will be appreciated, however, that these examples are merely illustrative of the variety of possible types of information that may be accessed/changed. Moreover, in various embodiments, the school information module 22 may be configured to provide differing levels of access to different classes of users. For example, a school administrator may be able to view and edit any information stored by the school information module 22, whereas a student may only be able view and edit student information of that particular student.

The clinical rotation management system 12 may also include the facility information module 24. The facility information module 24 may be configured to receive and manage information related to clinical rotations from one or more medical facilities, such as hospitals, medical centers, clinics, labs, doctor's offices, and the like. This information may be employed by the rotation management module 20 to create and manage the clinical rotation schedules. Accordingly, the facility information module 24 may receive and manage any one of a number of suitable types of clinical rotation related data. For example, the module 24 may receive medical staff information, site information, student information, rotation parameter information, affiliation information, and so forth.

Medical staff information may include, but is not limited to, medical staff names, titles, badge numbers, contact information, photographs, schedules, certifications, degrees, addresses, office numbers, and the like. Site information may include, but is not limited to, medical facility name, abbreviations, locations, number of beds, maximum student capacity, facility type, number of clinical rotations offered by the facility, types of clinical rotations offered by the facility (e.g., catheter lab, pediatrics, intensive care units, emergency room, psychiatric, operating room, rehabilitation, surgical care, etc.), other suitable scheduling information, and so forth. Student information may include a listing of students scheduled for clinical rotations at the medical facility, the time/data of those rotations, an attendance record for the students, and so forth.

Rotation parameters may include, but are not limited to, background check guidelines, drug screening guidelines, immunization guidelines, HIPPA guidelines for medical facilities, security guidelines, certification parameters (e.g., CPR certification, course work, etc.), supervisor to student ratios, and so forth. Affiliation information may include details, such as starting and ending dates, for affiliation agreements between the medical facility and any schools that are affiliated with it.

In addition to receiving and managing the facility information, the facility information module 24 may also be configured to enable a user, such as a hospital administration, a doctor, or a nurse to view and edit some or all of the facility information. For example, the facility information module 24 may enable a user to view the medical staff information for a particular member of the medical staff, to edit that information (e.g., add a new qualification or preference), and then to resave that information. Similarly, the user could view/edit rotation parameters or site information or add/edit affiliation agreements. It will be appreciated, however, that these examples are merely illustrative. Furthermore, in various embodiments, the facility information module 24 may be configured to provide differing levels of access to different classes of users. For example, a hospital administrator may be able to view and edit any information maintained by the facility information module 24, whereas a doctor may only be able view and edit the medical staff information of that particular doctor.

As illustrated in FIG. 1, the clinical rotation management system 12 may also include the maintenance module 26. The maintenance module 25 enables a system administrator to add, delete, or modify site eligibility for users of the system. For example, the maintenance module 26 may enable the system administrator to add new hospital administrators, school administrators, and the like to the system 12. Moreover the maintenance module 26 may also enable some users to add additional users with varying levels of system access privilege. For example, a school administrator could use the maintenance module 26 to add students to the system 12 while limiting their access to just viewing and editing their own student information. However, this example is merely exemplary and in various embodiments, any number of user management functions, as known to those of ordinary skill in the art, may be employed by the maintenance module 26.

The system 12 may also include the notice module 28. As mentioned above, the rotation management module 20 may be configured to manage the addition of new clinical rotations, the scheduling of those clinical rotations, and/or the editing of those clinical rotations. When new schedules or changes are made, it may be desirable to inform those individuals or users affected of those changes. As such, the notice module 28 may be configured to provide notice to the school, students, faculty, and/or medical staff of the changes/additions to the clinical rotation schedules or other information related to clinical rotation schedules.

The medical facility system 14 and the school system 16 may be configured to enable users from a medical facility and a school, respectively, to input information and select criteria and parameters relevant to the creation of the clinical rotation schedule. In addition, the medical facility system 14 and the school system 16 may enable the users to interact with the clinical rotation management system 12 over the network to view or edit the clinical rotation schedule.

FIG. 2 illustrates one example of a clinical infrastructure 100 configured in accordance with one embodiment of the infrastructure 10 of FIG. 1. As shown, the infrastructure 100 includes one exemplary configuration of the clinical rotation management system 12, the medical facility system 14, the school system 16, and the network 18. It will be appreciated, however, that FIG. 2 provides merely one example of each of these systems that may be used with the embodiments, and, as such, each illustrated system (12-16) is generally intended to encompass any suitable type of computer or processing device.

The clinical rotation management system 12 may be any computer or processing device such as, for example, a server, a blade server, general-purpose personal computer (“PC”), Machintosh, workstation, Unix-based computer, or any other suitable device or computer other than general purpose computers including computers without conventional operating systems. Furthermore, the system 12 may be adapted to execute any operating system including Linux, UNIX, Windows Server, or any other suitable operating system. Moreover, the system 12 may also include or be communicably coupled with a web server and/or a mail server.

The system 12 may also include a processor 102. The processor 102 executes instructions, such as instructions and manipulates the data to perform the operations of the system 12. In various configurations, the processor 102 may be, for example, a central processing unit (“CPU”), a blade, an application specific integrated circuit (“ASIC”), a field-programmable gate array (“FPGA”), or other suitable logic device. Although FIG. 2 illustrates a single processor 102 in system 12, multiple processors 102 may be used according to particular needs and reference to processor 102 is meant to include multiple processors 102 where applicable.

The system 12 also includes local memory 104. As illustrated, the memory 104 may include or store instructions 106 and the data 108. As those of ordinary skill in the art will appreciate, the instructions 106 and data 108 may be copied over to the memory 104 prior to being executed or manipulated by the processor 102. The memory 104 may include any memory or other computer readable storage module and may take the form of volatile or non-volatile memory including, without limitation, magnetic media, optical media, random access memory (“RAM”), read-only memory (“ROM”), removable media, or any other suitable local or remote memory component. The memory 104 may be internally or externally coupled to the system 12.

The instruction 106 may include software code or other computer readable instructions that can be executed by the system 12 or the systems 14 or 16 to generate one or more of the modules 20-28 and/or to execute one of the techniques described within this document. The instructions 106 may include software, firmware, wired or programmed hardware, or any combination thereof as appropriate. Indeed, the instructions 106 may be written or described in any appropriate computer language including C, C++, Java, J#, Visual Basic, assembler, Perl, any suitable version of 4GL, as well as others. For example, the instructions 106 may be implemented as Enterprise Java Beans (“EJBs”) or the design-time components may have the ability to generate run-time implementations into different platforms, such as J2EE (Java 2 Platform, Enterprise Edition), ABAP (Advanced Business Application Programming) objects, or Microsoft's .NET.

Further, while illustrated as being internal to the system 20, one or more processes associated with the instructions 106 may be stored, referenced, or executed remotely. For example, a portion of instructions 106 may create a web service that is remotely called (e.g., by the medical facility system 14), while another portion of instructions 106 may be an interface object bundled for processing at a client (e.g., the system 14 or 16). In another example, the majority of the instructions 106 may also reside—or their processing take place—on the system 14 or the system 16. Moreover, the instructions 106 may be a child or sub-module of another software module or enterprise application (not illustrated) without departing from the scope of this disclosure. The instructions 106 may also include code that is web-executable (e.g., java code) over the network 18. For example, the medical facility system 14 may execute code from the instructions 106 over the network 18.

The memory 104 may store also store data 108. The data 108 may include any suitable information related to creating a clinical rotation and/or to managing the operation of the system 12. For example, the data 108 may some or all of the information stored in the clinical rotation database 30. The data 108 may be generated by the system 12 or, as described below, may be received from the system 14 and/or the system 16.

As illustrated, the system 12 may include or be communicably coupled with a storage system 110. The storage system 110 ay include one or more persistent storage devices (e.g., hard drives, etc) that form a storage backbone for the system 12. In one embodiment, the storage system 110 may store the clinical rotation database 30. The storage system 110 may include one or more hard disk drives, semiconductor memories, and the like that are coupled, either internally or externally, to the system 12 via a direct connection, such as an integrated drive electronics (“IDE”) connection, a small computer systems interface (“SCSI”) connection, a Serial ATA (“SATA”) connection, or other suitable communicable connection. As shown, the storage system 110 allows for the system 12 to dynamically store and retrieve instructions 108 or data 145 from the storage system 110. For example, the instructions 106 or the data 108 may be copied over the memory 104 prior to execution of the instructions 106 or use of the data 108.

The system 12 may also include interface 112 for communicating with other computer systems, such as the systems 14 and 16, over the network 18. In certain embodiments, the system 12 receives data from internal or external senders through the interface 112 for storage in the memory 104, for storage in repository 110, and/or for processing by processor 102. Generally, the interface 112 comprises logic encoded in software and/or hardware in a suitable combination and operable to communicate with network 18. More specifically, the interface 112 may comprise software supporting one or more communications protocols associated with the network 18 or hardware operable to communicate physical signals. In one embodiment, the interface 117 may be a configured to enable interface with the system 20 via a virtual private network (“VPN”), Secure Shell (“SSH”) tunnel, or other secure network connection.

The network 18 facilitates wireless or wireline communication between the system 12 and any other local or remote computer, such as the systems 14 and 16. The network 18 may be all or a portion of an enterprise or secured network. In another example, network 18 may be a VPN merely between one or more of the systems 12, 14, and 16 across a wireline or wireless link. Such an example wireless link may be via 802.11a, 802.11b, 802.11g, 802.11n, 802.20, WiMax, and many others. While illustrated as a single or continuous network, the network 18 may be logically divided into various sub-nets or virtual networks without departing from the scope of this disclosure, so long as at least portion of network 18 may facilitate communications between one or more of the systems 12, 14, and 16.

The network 18 encompasses any internal or external network, networks, sub-network, or combination thereof operable to facilitate communications between various computing components in infrastructure 100. The network 18 may communicate, for example, Internet Protocol (“IP”) packets, Frame Relay frames, Asynchronous Transfer Mode (“ATM”) cells, voice, data, and other suitable information between network addresses. The network 18 may include one or more local area networks (“LANs”), radio access networks (“RANs”), metropolitan area networks (“MANs”), wide area networks (“WANs”), all or a portion of the global computer network known as the Internet, and/or any other communication system or systems at one or more locations. In certain embodiments, network 18 may be a secure network associated with the enterprise and certain local or remote clients.

The medical facility system 14 and the school system 16 may include any computing device operable to connect or communicate with the system 12 or the network 18 using any suitable type of communication link. At a high level, the systems 14 and 16 may each include or execute a graphical user interface (“GUI”) 114 and comprise an electronic computing device operable to receive, transmit, process and store any appropriate data associated with infrastructure 100. For ease of illustration, the systems 14 and 16 are described in terms of being used by one user but many users may use one computer or that one user may use multiple computers.

The GUI 114 is a graphical user interface operable to allow the user of systems 14 and/or 16 to interface with at least a portion of the infrastructure 100 for any suitable purpose, such as viewing an application or data. Generally, the GUI 114 provides the particular user with an efficient and user-friendly presentation of data provided by or communicated within infrastructure 100. In various embodiments, the GUI 114 may comprise a plurality of customizable frames or views having interactive fields, pull-down lists, and buttons operated by the user. The GUI 114 may also present a plurality of portals or dashboards. It will be understood, however, that the GUI 114 contemplates any graphical user interface, such as a generic web browser or touchscreen that processes information in infrastructure 100 and efficiently presents the results to the user. The GUI 114 can accept data from the system 12 via web browser (e.g., Microsoft Internet Explorer or Netscape Navigator) and return the appropriate HTML or XML responses using the network 18.

As described above, in one embodiment, the rotation management module 20 may be configured to manage the clinical rotations for the system 12. For example, FIG. 3 is a flow chart illustrating an exemplary technique 130 for managing clinical rotations in accordance with one embodiment. The technique 130 may be performed by the rotation management module 20 or by another suitable system.

As indicated by block 132 of FIG. 3, the technique 130 may begin by prompting a user with a rotation management selection screen. In one embodiment, the rotation management module 20 is configured to display the rotation management selection screen on the GUI 114 of either the system 14 or the system 16. Alternatively, the rotation management selection screen may be displayed in another suitable manner or on another suitable computer or computerized device (e.g., a mobile phone over a wireless connection).

As shown in FIG. 3, the rotation management selection screen may present one or more choices to the user. These choices may include a choice 134 to request a new clinical rotation, a choice 136 to create a new rotation schedule, and a choice 138 to view/edit an existing rotation schedule. It will be appreciated that the selection screen may alternatively include other choices or only a subset of the choices illustrated in FIG. 3. If the user selects the choice 134 to request a new clinical rotation, the rotation management module 20 may initiate a process to request the creation of a new clinical rotation. As will be appreciated, creating a new clinical rotation may involve the collaboration of a medical facility and one or more schools. As such, in some embodiments, creating a new clinical rotation includes a request process that allows the medical facility and the school or schools to agree on the creation of the clinical rotation.

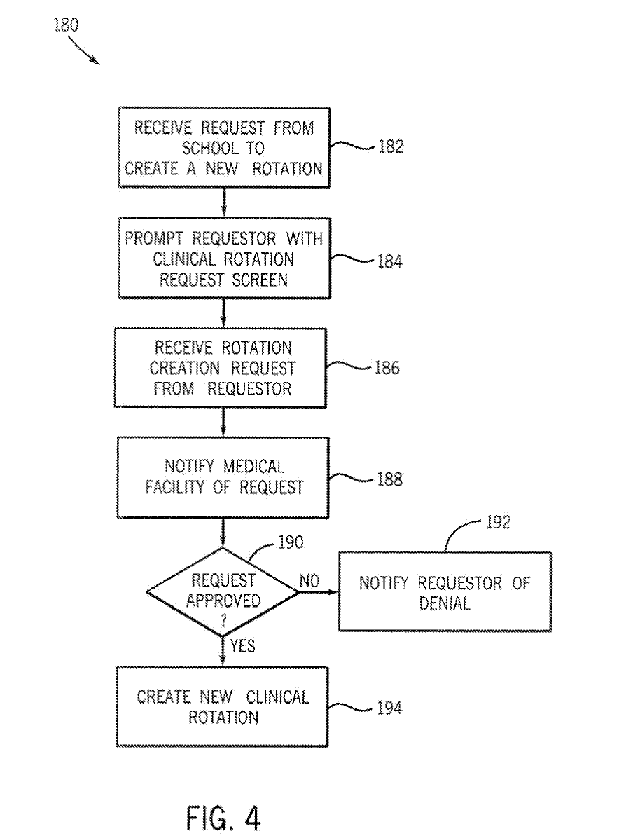

FIG. 4 is a flow chart illustrating an exemplary technique 180 for requesting the creating of a new clinical rotation in accordance with one embodiment. In one embodiment, the system 12 may execute the technique 180. The technique 180 may begin with the receipt of a request from a school to create a new clinical rotation, as indicated by block 182. For example, the rotation management module 20 may receive a request from a user of the school system 16 over the network 18.

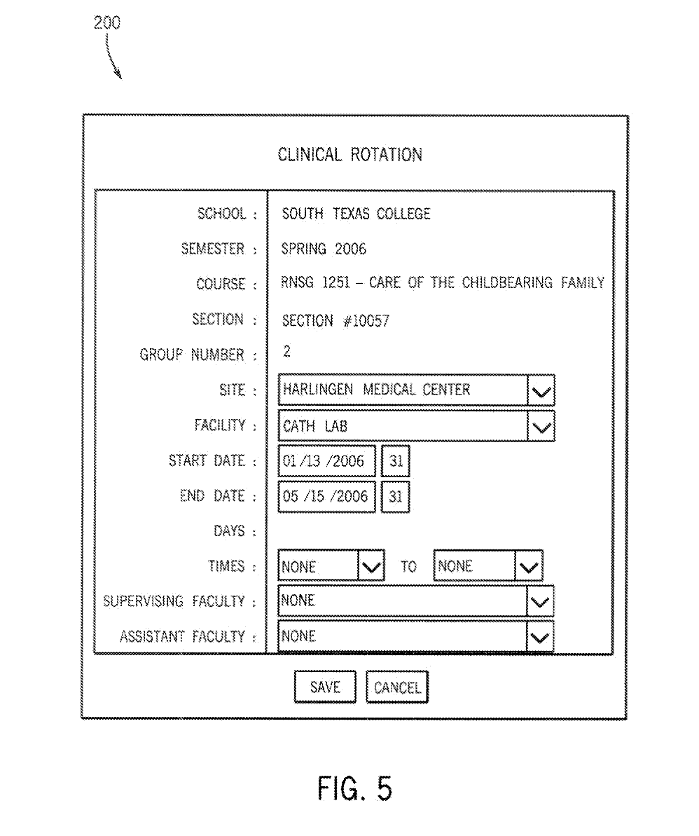

Once the request has been received, the technique 180 may involve prompting the requestor with a clinical rotation request screen. The clinical rotation request screen provides a mechanism for the requestor to input the information employed by the rotation management module 20 to create a new rotation. FIG. 5 illustrates an exemplary clinical rotation selection screen 200 in accordance with one embodiment. As shown in FIG. 5 the clinical rotation request screen 200 prompts the requestor for the school name, medical facility for the rotation, the type of rotation desired (e.g., catheter lab, pediatrics), the course number of the proposed rotation, the dates, and so forth. By making selections on the clinical rotation selection screen 200, the requestor is able to readily prepare a request for a new clinical rotation. It will be appreciated, however, that the screen 200 is merely exemplary and in alternate embodiments, other suitable information besides or in place of the information shown if FIG. 5 may be requestor employed.

After receiving the rotation creation request form the requestor (block 186), the technique 180 may include notifying the requested medical facility of the rotation creating request, as indicated in block 188 For example, the rotation management system 20 may transmit an email to a user of the medical facility system 14 notifying them of the request. Other suitable notification techniques may also be employed. If the request is denied by the medical facility (block 190), the technique 180 may notify the requestor of the denial (block 192). However, if the request is approved, the technique 180 creates a new clinical rotation, as indicated by block 194. In alternate embodiments, however, the clinical rotation may be created unilaterally. For example, the medical facility can choose to offer a new clinical rotation without the school's approval.

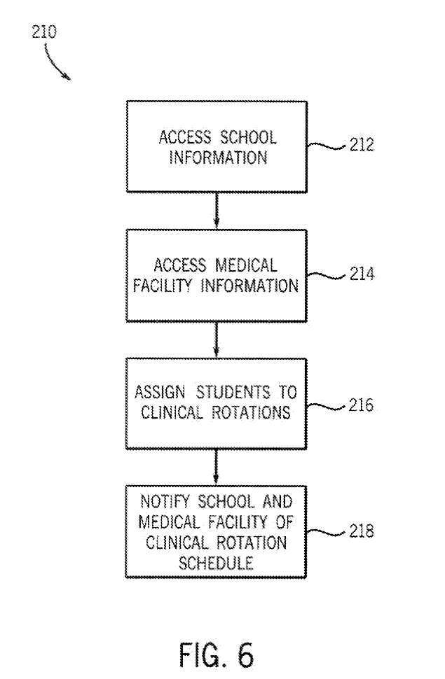

The rotation management module 20 may also create a schedule for the clinical rotation (block 136 of FIG. 3). For example, FIG. 6 is a flow chart illustrating an exemplary technique 210 for creating a clinical rotation schedule in accordance with one embodiment. The technique 210 may be performed by the clinical rotation management system 12. However, it will be appreciated, that in alternate embodiments, other suitable systems or modules may execute the technique 210.

As indicated by block 212 of FIG. 6, the technique 210 may include accessing or receiving school information related to the clinical rotation schedule. For example, in one embodiment, the rotation management module 20 may receive information from the school information module 22 and/or the clinical rotation database 30. Alternatively, the rotation management module 20 may receive the school information directly from the school system 16. As mentioned above, the school information may include any suitable clinical rotation related information. For example, the school information may include student information, faculty information, school information, and/or course information.

As indicated by block 214 of FIG. 6, the technique 210 may also include accessing or receiving information related to a clinical rotation schedule from one or more medical facilities. In various embodiments, block 214 may include receiving information from the faculty information module, the clinical database 30, or the medical facility system 14. For example, in one embodiment, the rotation management module 20 may access medical staff information, site information, site parameters, and so forth, stored in the clinical rotation database.

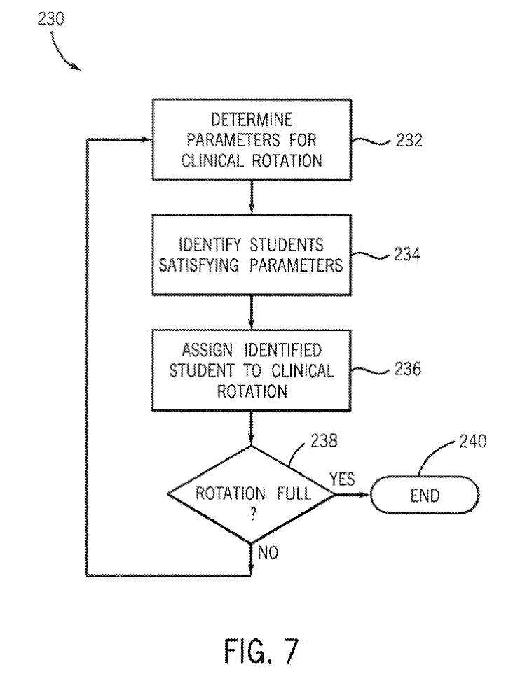

The technique 210 may also include assigning students to clinical rotations based on the accessed information and/or other clinical rotation parameters as indicated by block 216. In various embodiments, assigning students to clinical rotations may include any suitable technique for assigning students to a clinical rotation. For example, FIG. 7 is a flow chart illustrating an exemplary technique 230 for assigning students to a clinical rotation in accordance with one embodiment. As illustrated by block 232, the technique 150 may begin by determining one or more parameters for the clinical rotation to be scheduled. The parameters for the clinical rotation may include any one or a number of suitable parameters or guidelines that the medical facility may consider in selecting students for a clinical rotation. For example, the parameters may include background check status/results, CPR certification, drug screening, immunization records, educational background, year in school, scheduling availability, and so forth.

Next, the technique 230 may involve identifying students satisfying the determined parameters, as indicated by block 234. For example, in one embodiment, the rotation management module 20 may be configured to compare student information against the determined parameters to identify one or more students that satisfy each of the parameters. Advantageously, because the technique 234 only identifies those students that satisfy the parameters for the clinical rotation, the medical facility hosting the clinical rotation can be confident that each of the students assigned to the rotation are qualified to participate. For example, one of the parameters for the clinical rotation may be completion of a background check or a series of immunizations. Advantageously, this feature of the technique 210 enable the clinical rotation schedule to automatically comply with HIPPA guidelines or rules and/or state laws that address authorized personnel in medical facilities. This automatic compliance advantageously may help the medical facility and the school to limit their liability from unqualified students being places in particular clinical rotation.

After identifying students that satisfy the parameters for the clinical rotation, the technique 230 may involve assigning one of the identified students to the clinical rotation, as indicated by block 236. Any suitable technique for selecting one of the identified students from the subset of qualified students may be employed during the technique 230. For example, in one embodiment, the student with the earliest registration date on the clinical rotation management 12 may be assigned to the clinical rotation. In other words, in this embodiment, qualified students may be assigned on a “first come—first served” basis. However, in other embodiments, other suitable selection techniques may be employed. For example, the most senior student may be selected, the student located closest to the medical facility geographically may be selected, the student closest to graduating may be selected, and/or students with other selection criteria or combination of selection criteria may be selected.

After assigning a qualified student to the clinical rotation schedule, the technique 230 may include determining whether the clinical rotation is full. For example, if the clinical rotation being scheduled has ten available slots, it will be full after the tenth slot is assigned. If the clinical rotation is full, the technique 230 may end, as indicated by block 240. If, on the other hand, the clinical rotation is not full, the technique 150 may cycle back to block 236 to assign another student in the same manner described above with regard to block 236.

Once the clinical rotation is full or there are no remaining qualified students to assign to the clinical rotation, the clinical rotation schedule is complete (although it may be edited at a later time). In various embodiments, the completed clinical rotation schedule may include a variety of schedule-related pieces of information. For example, the clinical rotation schedule may include one or more of the following: (1) a listing of students scheduled for the clinical rotation; (2) notification of any student or faculty changes from a previous version of clinical rotation schedule; (3) time, dates, and location for each student scheduled; (4) an identification of a faculty members assigned to each rotation, student, or group of students; (5) an assigned facility supervisor for each student and/or student cluster; (6) a confirmation that each student placed on the clinical rotation meets the parameters for the rotation (e.g., attendance, procedure mastery, and so forth); and (7) information regarding affiliation agreements between the medical facility and the school.

Returning now to block 218 of FIG. 6, after assigning students to clinical rotations, the technique 130 may involve notifying the school, students, faculty, and/or medical staff associated with the clinical rotation (hereafter referred to as “the affected parties”) of the clinical rotation schedule. This notification may be handled by the notice module 28. In one embodiment, this notification involves sending one or more email messages to the affected parties. Notifying the school and medical facility may also include posting the clinical rotation on a website or computer network. For example, the clinical rotation management system 12 may store the clinical rotation schedule such that the medical facility system 14 and/or the school system 16 may access the clinical rotation schedule over the network 18.

Looking back to FIG. 3, the technique 130 may also include viewing and/or editing existing clinical rotations schedules, as indicated by block 138. For example, the rotation management module 20 may be configured to enable the user to view existing clinical rotation schedules sorted by date (block 140), sorted by school (block 142), sorted by medical facility (block 144), sorted by rotation type (block 146), or sorted by another suitable criteria (not shown). After receiving a selection for one of the clinical rotation schedules from a user (block 148), the rotation management module 20 may display the selected clinical rotation schedule, as indicated by block 150 (e.g., transmit the clinical rotation schedule to the GUI 114 of the school system 16). At that point, the user may choose to edit the rotation schedule, as indicated by block 152. For example, the user may rerun the technique 210 to add more students to the clinical rotation schedule, may remove students from the clinical rotation, may change times/dates of the rotation, and so forth. After making the changes to the clinical rotation schedule, the technique 130 may include closing/saving the selected clinical rotation schedule.

It will be appreciated that the preceding flowchart and accompanying description illustrate exemplary methods. Accordingly, the infrastructures 10 and 100 described above contemplate using or implementing any suitable method for performing these and other tasks. It will be understood that these methods are for illustration purposes only and that the described or similar methods may be performed at any appropriate time, including concurrently, individually, or in combination. Further, although this disclosure has been described in terms of certain embodiments and generally associated methods, alterations and permutations of these embodiments and methods will be apparent to those skilled in the art. Accordingly, the above description of example embodiments does not define or constrain this disclosure. Other suitable changes, substitutions, and alterations are also possible without departing from the spirit and scope of this disclosure.

What is claimed is:

1. A computerized method comprising:
accessing first clinical rotation related information associated with a school;
accessing second clinical rotation related information associated with a medical facility; and
creating a clinical rotation schedule based on the first information and the second information.

2. The method of claim 1, wherein creating the clinical rotation schedule comprises:
determining a clinical rotation parameter for the clinical rotation;
identifying a student from the school that satisfies the clinical rotation parameters; and
assigning the identified student to the clinical rotation.

3. Te method of claim 2, wherein determining the clinical rotation parameter comprises determining an immunization guideline for the clinical rotation.

4. The method of claim 2, wherein determining the clinical rotation parameter comprises determining a HIPPA guideline.

5. The method of claim 2, wherein determining the clinical rotation parameter comprises determining a plurality of clinical rotation parameters.

6. The method of claim 2, wherein the identifying comprises identifying the first student to be registered on a clinical rotation management system that satisfies the clinical rotation parameters.

7. The method of claim 1, wherein accessing the first information comprises accessing a database storing information from a plurality of students.

8. The method of claim 1, comprising:
receiving a request from the school to create the clinical rotation;
notifying the medical facility of the request; and
prompting a medical facility system to approve the request.

9. The method of claim 8, comprising transmitting a clinical rotation request screen to a school system.

10. The method of claim 1, comprising notifying a school system of the creation of the clinical rotation schedule.

11. A computer readable medium comprising:
code adapted to access first clinical rotation related information associated with a school;
code adapted to access second clinical rotation related information associated with a medical facility; and
code adapted to create a clinical rotation schedule based on the first information and the second information.

12. The computer readable medium of claim 11, wherein the code adapted to create the clinical rotation schedule comprises:
code adapted to determine a clinical rotation parameter for the clinical rotation;
code adapted to identify a student from the school that satisfies the clinical rotation parameters; and
code adapted to assign the identified student to the clinical rotation.

13. The computer readable medium of claim 12, wherein the code adapted to determine the clinical rotation parameter comprises code adapted to identify a HIPPA guideline.

14. The computer readable medium of claim 12, comprising:
code adapted to receive a request from the school to create the clinical rotation;
code adapted to notify the medical facility of the request; and
code adapted to prompt a medical facility system to approve the request.

15. A clinical rotation management system comprising:
a rotation management module configured:
to access first clinical rotation related information associated with a school;
to access second clinical rotation related information associated with a medical facility; and
to create a clinical rotation schedule based on the first information and the second information.

16. The clinical rotation management system of claim 15, comprising a clinical rotation database storing the first information and the second information.

17. The clinical rotation management system of claim 15, wherein the rotation management module is configured:
to determine a clinical rotation parameter for the clinical rotation;
to identify a student from the school that satisfies the clinical rotation parameters; and
to assign the identified student to the clinical rotation.

18. The clinical rotation management system of claim 15, comprising a school information module configured:
to receive the first information; and
to enable a user to access the first information.

19. The clinical rotation management system of claim 18, wherein the school information module is configured to enable the user to modify the first information.

20. The clinical rotation management system of claim 15, comprising a notice module configured to notify a medical facility system by email of the creation of the clinical rotation module.
